(19) United States
(12) Patent Application Publication
(10) Pub. No.: US 2009/0239079 A1
(43) Pub. Date: Sep. 24, 2009

(54) Process for Preventing Plating on a Portion of a Molded Plastic Part

(76) Inventors: Mark Wojtaszek, Canton, CT (US); Robert Hamilton, Torrington, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/050,709

(22) Filed: Mar. 18, 2008

(51) Int. Cl. B32B 9/00; B05D 1/18

(52) U.S. Cl. 428/411.1; 427/430.1

(57) ABSTRACT

The present invention relates to a method of incorporating a catalytic poison into a non-plating grade resin portion of a double shot molded plastic part, to retard the tendency of any electroless plating chemistry to be deposited on that portion that contains the catalytic poison. After surface treatment, only one portion of the molded part becomes receptive to electroless plating while the other portion does not.

### FIELD OF THE INVENTION

The present invention relates to an improved method of selectively plating a molded plastic article.

### BACKGROUND OF THE INVENTION

Molded-one piece articles are used, for example in forming printed circuit and wiring boards. In many instances, two separate molding steps are used to form two portions of the article. For example, two-shot molding is a means of producing devices having two portions, such as molded interconnect devices (including printed circuit boards), from a combination of two injection molded polymers. The process is also used for producing two-colored molded plastic articles and for combining hard and soft plastics in one molded part.

A typical two-shot molding process includes the following steps:
1. Mold first shot;
2. Overmold first shot with second polymer;
3. Etch and activate exposed areas; and
4. Plate with electroless nickel or electroless copper to deposit plating material.

In addition to possessing the required end use properties of the product, the two polymers selected for use must be compatible in the two-shot molding process and must also provide a suitable combination for plating. In order to plate one of the polymers and not the other, it is generally been found necessary to either selectively activate the polymer to be plated after the molding process or to use a polymer having a catalyst disposed therein, i.e., a polymer containing a certain percentage of palladium, as described for example in U.S. Pat. No. 7,189,120 to Zaderej, the subject matter of which is herein incorporated by reference in its entirety. Other two-shot (or multi-shot) molding processes are described in U.S. Pat. No. 5,407,622 to Cleveland et al. and in U.S. Pat. No. 6,601,296 to Dailey et al., the subject matter of each of which is herein incorporated by reference in its entirety.

However, these processes can still allow extraneous plating of at least part of the non-plateable polymer, especially at locations adjacent to where the two polymers meet, which can affect the performance of the molded interconnect device. Thus, it would be desirable to develop a process of two-shot injection molding that provides for a clearer line of demarcation between the plateable portion and the non-plateable portion of the molded interconnect device.

The present invention relates generally to molded articles having a first portion that is receptive to electroless plating thereon and a second portion which substantially inhibits electroless plating thereon. More particularly, the present invention relates to molded blanks for printed circuit boards and molded articles, and processes for forming the blanks and plating portions of the articles which include two separate molding steps to form portions of the articles.

### SUMMARY OF THE INVENTION

It is an object of the present invention to form a molded article for adherent metallization, such as a printed circuit board with a circuit pattern, by a two shot injection molding process, wherein the first shot forms the circuit pattern and the second shot forms a support structure around the circuit pattern.

It is another object of the present invention to form a molded article for selective metallization to provide a clear line of demarcation between the plateable portion and the non-plateable portion of the molded article.

It is still another object of the present invention to provide a process for selective metallization of a molded article that minimizes or eliminates metal adherence to the non-plateable portion of the molded article.

To that end, the present invention relates generally to a selectively plated article comprising:
a) a first plastic portion comprising a catalytic poison substantially uniformly dispersed therein that inhibits electroless plating on the first plastic portion; and
b) a second plastic portion that is receptive to electroless plating thereon and having a layer of electroless metal plating deposited thereon;

wherein the first plastic portion is at least substantially free of electroless metal plate.

The present invention also relates generally to a method of plating a plastic part, the method comprising the steps of.
a) providing a plastic part comprising:
   i) a first plastic portion comprising a catalytic poison substantially uniformly dispersed therein that inhibits electroless plating on the first plastic portion; and
   ii) a second plastic portion that is receptive to electroless plating thereon;
b) preparing the plastic part to accept electroless plating on the second plastic portion that is receptive to electroless plating; and
c) plating the plastic part in an electroless plating bath;
whereby the first plastic portion is at least substantially free of electroless plating but the second plastic portion is, at least in part, plated.

### DETAILED DESCRIPTION OF THE PREFERRED EMBODIMENTS

A dual-shot injection molding process, as discussed above, forms first and second “shots” respectively from one and then the other of a non-plateable polymer and a plateable polymer that together comprise the plastic part. The two portions are forced, under pressure into a closed mold or molds and the materials solidify within the mold cavity. The molded material retains the shape of the mold, and the finished molded part is then ejected from the mold cavity.

In order to prevent any electroless metal from plating onto the non-plateable portions, the present invention relates to a method of incorporating a catalytic poison into a portion of the double-shot molded plastic part, to retard the tendency of subsequently applied electroless plating chemistry to create a plated deposit on that portion containing the catalytic poison compound. The double shot molded plastic part can then be processed through a standard plating-on-plastic process line that utilizes a chromic acid/sulfuric acid etch or alkaline permanganate solution, a neutralizer, colloidal activation, acceleration, and then subjected to electroless copper or electroless nickel plating chemistry. Other plating-on-plastic processes known in the art may also be used in the practice of the invention. In the alternative, the plastic or resin to be plated on can have a plating catalyst, such as palladium, incorporated into the resin and the plastic or resin portion to be free from plate can have the catalytic or plating poison incorporated into it. Thus what is important is that the plastic or resin which in intended to be free from plate has the catalytic or plating poison and that the other portion of the article not have the catalytion plating poison. This allows for either the entire article to be activated or for only portions to be activated, but in either case the areas with the catalytic or plating poison will not be plated (even if activated).

After being processed through the steps of the plating-on-plastic line, only one portion of the molded part becomes receptive to electroless plating while the other portion does not. The innovative process described herein also eliminates electroless copper and electroless nickel plating chemistries from cross boundary interfaces throughout the part and creating extraneous plate across two different resin types.

The present invention incorporates a catalytic poison, such as a sulfur-containing compound, into specific portions of the double shot resin matrix. The result is a molded plastic part that exhibits improved plating quality and reduced plating scrap and also solves a plaguing industry problem regarding extraneous plating of double shot molded pieces. The sulfur-rich plastic surface renders the plating chemistry ineffective to forming potential bonding sites for subsequent metallization thus accomplishing the desired effect. The catalytic poison must be compatible with the polymer matrix such that the catalytic poison can be uniformly distributed in the polymer matrix.

The catalytic poison is chosen so as to be compatible with the polymer matrix of the first plastic portion and to allow uniform distribution of the catalytic poison therein. Optionally, but preferably, the sulfur-containing compound is a non-polar species. It is believed that the sulfur-containing compound functions as a palladium poison to quench catalysis and also serves as an overstabilizer to prevent electroless plating on this portion of the part. The catalytic poison also acts as a surface concentration maximization agent after etching/neutralization. Finally, the catalytic poison is not affected by the etching and neutralization steps other than to achieve surface concentration maximization. One of the benefits of the present invention is that there is a clean line of demarcation between the plated portion of the substrate and the non-plated portion of the substrate that is not observed in processes of the prior art.

In one embodiment, the non-plating portion has a sulfur-containing compound dispersed therein having for example, R—SH or R═S bond, and the plating portion has a palladium catalyst dispersed therein.

The catalytic poison in one embodiment has the structure R—SH or R═S, where R is selected from the group consisting of alkyl groups, alkene groups, alkyne groups, aromatic groups, other organic ring structures and combinations of the foregoing.

Examples of suitable materials include:

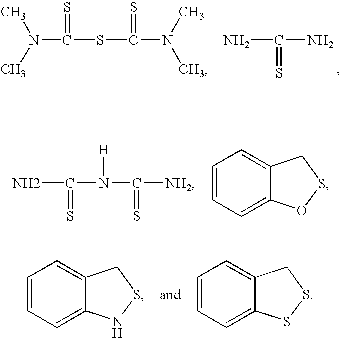

In another embodiment, the catalytic poison is a sulfur containing compound that is used as a stabilizer in electroless plating such as 2-mercaptobenzothiazole, which is used as a stabilizer in electroless copper plating and thiourea, which is used as a stabilizer in electroless nickel plating. Other stabilizers would also be known to those skilled in the art. In addition, while sulfur species are generally preferred, in the case of electroless copper or and electroless nickel processes, compatible iodo compounds may also be usable as the catalytic poison in the non-plateable portion. An example of a suitable iodo compound is iodobenzoic acid. Other suitable iodo compounds would also generally be known to those skilled in the art. Selenium compounds can also be used. It is preferable however that the catalytic poison does not contain any metallic stabilizer such as lead, antimony or bismuth because these materials are environmentally less preferred.

Several suitable stabilizers are available from the R. T. Vanderbilt Company, Inc. (Norwalk, Conn.) under the tradename VANAX®. These compounds include VANAX® 882A, a thiadiazole derivative, VANAX® 829, a substituted 1,3,4-thiadiazole, VANAX® 196 solid, an alkyl dithiophosphate, VANAX® 189 solid, a 1,3,4-thiadiazole derivative on an inert carrier, VANAX® 189, an ether derivative of 2,5-dimercapto-1,3,4-thiadiazole, and VANAXC DTDM, 4,4′-dithiodimorpholine, among others. Other similar sulfur-bearing materials would also be usable in the practice of the invention.

In one embodiment, the process of the invention relates to a method of plating a plastic part, the method comprising the steps of:
a) providing a plastic part comprising a first plastic portion comprising a material substantially uniformly dispersed therein that inhibits electroless plating on the first plastic portion and a second plastic portion that is receptive to electroless plating thereon;
b) preparing the plastic part to accept electroless plating on the second plastic portion that is receptive to electroless plating; and
c) plating the plastic part in an electroless plating bath;
whereby the first plastic portion remains at least substantially free of electroless plating.

The amount of catalytic poison to be added to the first plastic portion to prevent plating is dependent in part on the catalytic poison that is used as well as the particular plastic that is being used. The amount of catalytic poison can be determined by adding the poison incrementally to the plastic portion until plating stops. The amount of catalytic poison is measured based on the sulfur content of the catalytic poison. The concentration of catalytic poison, measured as sulfur, is typically at least about 0.015 mg/, more preferably about 0.025 mg/L to about 2.5 mg/L, and most preferably about 0.05 mg/L to about 5.0 mg/L.

As discussed above, the double-shot molded piece comprises a plating portion and a non-plating portion. Various polymers may be used for each portion and examples of suitable materials and suitable combinations of materials are provided below in Table 1. Other suitable combinations of resin in the plating portion and the non-plating portion would also be known to those skilled in the art.

TABLE 1
Examples of Resin Combinations Usable in the Invention

| | Plating Portion | Non-Plating Portion |
|---|---|---|
| 1. | ABS | ABS/PC |
| 2. | ABS | PC |
| 3. | ABS | Nylon |
| 4. | ABS | Polypropylene |
| 5. | ABS | ABS/PC/polypropylene |
| 6. | ABS | PPO |
| 7. | ABS/PC | PC |
| 8. | LCP | SPS |
| 9. | LCP, palladium filled | LCP |
| 10. | SPS, palladium filled | SPS |

ABS—acrylonitrile butadiene styrene
PC—polycarbonate
PPO—polyphenylene oxide
LCP—liquid crystal polymer
SPS—syndiotactic polystyrene

It is generally preferred that the non-plating portion be substantially 100% resin, without any filler materials other than the catalytic poison material. This is preferred because as the parts are etched during processing, there is no filler that is removed and thus no bonding sites are created. While there may be some filled materials that can be used for the non-plating portion, these materials are of very limited offering. The filled materials can cause extensive extraneous plating across part lines as bonding sites are created by the etch chemistry. While scratches, nicks, knurls, etc. can also cause undesired plating, the inclusion of the catalytic poison in accordance with the present invention will eliminate this problem.

In order to prepare the plateable plastic portion for electroless plating thereon, the plastic part is processed through one of several typical electroless plating cycles. Various electroless plating cycles are known and may be used in the present invention. Several of these cycles are set forth below and are given by way of example and not limitation. In one embodiment, the electroless plating cycle includes the following steps:

1) Chromic acid/sulfuric acid or an alkaline permanganate/caustic mixture;

2) Neutralization;

3) Colloidal activation;

4) Acceleration; and

5) Electroless nickel or copper plating.

Cold water rinses are typically interposed between each of the steps of the process.

In another embodiment, the electroless plating cycle includes the following steps:

1) Chromic acid/sulfuric acid;

2) Neutralization;

3) Ionic palladium activation (acid or alkaline);

4) Ionic reducer, hypophosphite or dimethylaminoborane (DMAB) mixture; and

5) Electroless nickel or copper plating.

In still another embodiment, the electroless plating cycle includes the following steps:

1) Alkaline permanganate/caustic mixture;

2) Neutralization;

3) Ionic palladium activation;

4) Ionic reducer; and

5) Electroless nickel or copper plating.

In still another embodiment, if the plastic parts include a palladium catalyst, such as palladium particles, the electroless plating cycle includes the following steps:

1) Ionic reducer; and

2) Electroless nickel or copper plating.

Finally, if a liquid crystal polymer is used for the plateable portion of the plastic part, the electroless plating cycle includes the following steps:

1) Caustic etch;

2) Acid pre-dip for neutralization;

3) Colloidal activator;

4) Acceleration; and

5) Electroless nickel or copper plating.

In the alternative, the following process may also be used for liquid crystal polymers:

1) Caustic etch;

2) Acid pre-dip for neutralization;

3) Ionic palladium activation;

4) Ionic reducer; and

5) Electroless nickel or copper plating.

Again, cold water rinses are preferably interposed between each of the steps in the electroless plating cycle.

Other electroless plating processes known in the art would also be suitable for use in the present invention.

### EXAMPLE 1

An acrylonitrile butadiene styrene terpolymer (ABS) substrate was processed through the following cycle:
1. Chromic acid/sulfuric acid solution containing 450 g/l chromic acid and 350 g/l sulfuric acid with 0.1% w/v Metex® Spray Stop-L (available from MacDermid, Inc. of Waterbury, Conn.), applied at a temperature of 160° F. (71° C.) for 8 minutes
2. Cold water rinse (3)—for one minute.
3. Macuplex® 9339 Neutralizer (available from MacDermid, Inc. of Waterbury, Conn.)—5% by volume with 3.5% by volume hydrochloric acid, applied at a temperature of 115° F. (46° C.) for 2 minutes.
4. Cold water rinse (2) for one minute.
5. Macuplex® D-34 Concentrated Activator (available from MacDermid, Inc. of Waterbury, Conn.)—0.6% by volume with 20% by volume hydrochloric acid, applied at a temperature of 85° F. (29° C.) for 3 minutes.
6. Cold water rinse (2) for one minute.
7. Macuplex® 9369 Accelerator (available from MacDermid, Inc. of Waterbury, Conn.)—60 g/l, applied at a temperature of 120° F. (49° C.) for 2 minutes. If hard water is a problem, Maccelerator® 25 (available from MacDermid, Inc. of Waterbury, Conn.) may be substituted for Macuplex® 9369 Accelerator.
8. Cold water rinse (2) for one minute.
9. Macuplex® J-64 EN or Ultradep® 60 electroless copper (each available from MacDermid, Inc. of Waterbury, Conn.)
10. Cold water rinse (3) for one minute.
11. Additional processing steps as desired.

A plating grade ABS resin (available from GE) as the plateable portion and a GE 100% polycarbonate resin with the inclusion of 0.25% by weight of tetramethylthiuram monosulfide as the catalytic poison material was processed through the above cycle. Fine part lines were notice after electroless plating, distinguishing the two plastics. No extraneous plating was noticed after QC inspection.

### EXAMPLE 2

A liquid crystal polymer (LCP) substrate was processed through the following cycle:
1. Macudizer® 9276 (available from MacDermid, Inc. of Waterbury Conn.) 100% by volume M-79-224, applied at a temperature of 190° F. (88° C.) for 6-10 minutes.
2. Cold water rinse (3) for one minute.
3. Macudizer® 9278 Glass Etch (available from MacDermid, Inc. of Waterbury, Conn.) 55 g/l with 7% by volume sulfurric acid, applied at a temperature of 110° F. (43° C.) for 5 minutes.
4. Cold water rinse (2) for one minute.
5. Acid Dip—10% sulfiuric acid, applied at a temperature of 75° F. (24° C.) for 1 to 2 minutes.
6. Cold water rinse (2) for one minute.
7. Conditioner 90 (available from MacDermid, Inc. of Waterbury, Conn.)—10% by volume A, 5% by volume B and 2.5% by volume C, applied at 120° F. (49° C.) for 2 minutes.
8. Cold water rinse (2) for one minute.
9. Macuplex® D-34 Concentrate (available from MacDermid, Inc. of Waterbury, Conn.)—0.8% by volume D-34 Concentrate in 20% by volume hydrochloric acid, applied at 80° F. (27° C.) for 2 to 4 minutes.
10. Cold water rinse (2) for one minute.
11. Ultracel® 9369 (available from MacDermid, Inc. of Waterbury, Conn.)—60 g/L, applied at 120° F. (49° C.) for 2 to 3 minutes.
12. Cold water rinse (2) for one minute.
13. Macuplex® J-64 EN or Ultradep® 60 electroless copper (each available from MacDermid, Inc. of Waterbury, Conn.)
14. Cold water rinse (3) for one minute.
15. Additional processing steps as desired.

Steps 3 through 6 are only necessary if the parts to be plated contain glass as a filler and the surface appearance needs to be refined.

The above processing cycle works for various liquid crystal polymers. The processing cycle has been found to work particularly well for Vectra® LCP resins, such as Vectra® C810 resin (available from Ticona Corporation of Florence, Ky.).

While the invention has been described above with reference to specific embodiments thereof, it is apparent that many changes, modifications, and variations can be made without departing from the inventive concept disclosed here. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A selectively plated article comprising:
a) a first plastic portion comprising a catalytic poison substantially uniformly dispersed therein that inhibits electroless plating on the first plastic portion; and
b) a second plastic portion that is receptive to electroless plating thereon and having a layer of electroless metal plating deposited thereon;
wherein the first plastic portion is at least substantially free of electroless metal plate.

2. The plated article according to claim 1, wherein the catalytic poison is selected from the group consisting of organic sulfur compounds and organic iodo compounds.

3. The plated article according to claim 2, wherein the catalytic poison is a sulfur species having the formula R—SH or R═S, wherein R is selected from the group consisting of alkyl group, alkene groups, alkyne groups, aromatic groups, organic ring groups, and combinations of the foregoing.

4. The plated article according to claim 2, wherein the catalytic poison is selected from the group consisting of thiadiazoles and derivatives thereof, substituted thiadiazoles, alkyl dithiophosphates, thiadiazole derivatives on an inert carrier, ether derivatives of 2,5-dimercapto-1,3,4-thiadiazole, piperdinium pentamethylene dithiocarbamate.

5. The plated article according to claim 2, wherein the organic iodo compound is iodobenzoic acid.

6. The plated article according to claim 2, wherein the catalytic poison does not contain any metallic stabilizers.

7. The plated article according to claim 1, wherein the electroless metal plating layer is selected from the group consisting of electroless nickel and electroless copper.

8. A method of plating a plastic part, the method comprising the steps of:
a) providing a plastic part comprising:
i) a first plastic portion comprising a catalytic poison substantially uniformly dispersed therein that inhibits electroless plating on the first plastic portion; and
ii) a second plastic portion that is receptive to electroless plating thereon;
b) preparing the plastic part to accept electroless plating on the second plastic portion that is receptive to electroless plating; and
c) plating the plastic part in an electroless plating bath;
whereby the first plating portion is at least substantially free of electroless plating.

9. The method according to claim 8, wherein the electroless plating is selected from electroless copper and electroless nickel.

10. The method according to claim 8, wherein the second plastic portion is a resin selected from the group consisting of acrylonitrile butadiene styrene, acrylonitrile butadiene styrene/polycarbonate, liquid crystal polymers, palladium filled liquid crystal polymers and palladium filled syndiotactic polystyrene.

11. The method according to claim 8, wherein the first plastic portion is a resin selected from the group consisting of acrylonitrile butadiene styrene/polycarbonate, polycarbonate, nylon, polypropylene, acrylonitrile butadiene styrene/polycarbonate/polypropylene, polyphenylene oxide, polycarbonate, syndiotactic polystyrene and liquid crystal polymers.

12. The method according to claim 11, wherein the first plastic portion is substantially 100% resin.

13. The method according to claim 8, wherein the first plastic portion does not contain any filler materials that are capable of creating bonding sites thereon.

14. The method according to claim 8, wherein the catalytic poison is selected from the group consisting of sulfur species and organic iodo compounds.

15. The method according to claim 14, wherein the catalytic poison is a sulfur species having the formula R—SH or R═S, wherein R is selected from the group consisting of alkyl groups, alkene groups, alkyne groups, aromatic groups, organic ring groups, and combinations of the foregoing.

16. The method according to claim 14, wherein the catalytic poison is selected from the group consisting of thiadiazoles and derivatives thereof, substituted thiadiazoles, alkyl dithiophosphates, thiadiazole derivatives on an inert carrier, ether derivatives of 2,5-dimercapto-1,3,4-thiadiazole, piperdinium pentamethylene dithiocarbamate.

17. The method according to claim 14, wherein the organic iodo compound is iodobenzoic acid.

18. The method according to claim 14, wherein the catalytic poison does not contain any metallic stabilizers.

19. The method according to claim 8, wherein the catalytic poison is present in the first plastic portion at a concentration of between about 0.015 mg/L and about 5.0 mg/L based on sulfur.

20. The method according to claim 19, wherein the catalytic poison is present in the first plastic portion at a concentration of about

21. The method according to claim 8, wherein the plastic part is a double shot molded plastic part.

22. The method according to claim 8, wherein the second plastic portion comprises a filler material selected from the group consisting of either of a sulfur species or organic iodo compounds.

23. The method according to claim 8, wherein the second plastic portion contains a palladium catalyst.
